(19) United States
(12) Patent Application Publication
(10) Pub. No.: US 2026/0190079 A1
(43) Pub. Date: Jul. 2, 2026

(54) COMMUNICATION METHOD AND APPARATUS

(71) Applicant: HUAWEI TECHNOLOGIES CO., LTD., Shenzhen (CN)

(72) Inventors: Pengcheng Shi, Hangzhou (CN); Ying Chen, Hangzhou (CN); Feiran Zhao, Hangzhou (CN); Jun Wang, Hangzhou (CN)

(21) Appl. No.: 19/549,072

(22) Filed: Feb. 25, 2026

Related U.S. Application Data
(63) Continuation of application No. PCT/CN2024/117967, filed on Sep. 10, 2024.

(30) Foreign Application Priority Data
Sep. 12, 2023 (CN) 202311172390.6

(51) Int. Cl. H04W 68/02; H04W 76/20; H04W 76/30

(52) U.S. Cl. CPC H04W 68/02; H04W 76/20; H04W 76/30

(57) ABSTRACT

In a communication method, a first communication apparatus receives first information for determining a first resource, the first resource precedes a second resource in a time domain, the second resource comprises one paging occasion or a plurality of paging occasions that are consecutive. The first communication apparatus enters an idle state or an inactive state, and receives a first sequence on the first resource when a first condition is met. The first sequence is a sequence of a first type, and the first condition comprises at least one of: signal quality measured is less than or equal to a first threshold, or signal quality measured within a first time period is less than or equal to the first threshold. The first communication apparatus outputs first prompt signal based on the first sequence.

### CROSS-REFERENCE TO RELATED APPLICATIONS

This application is a continuation of International Application No PCT/CN2024/117967, filed on Sep. 10, 2024, which claims priority to Chinese Patent Application No. 202311172390.6, filed on Sep. 12, 2023. The disclosures of the aforementioned applications are hereby incorporated by reference in their entireties.

### TECHNICAL FIELD

Embodiments of this disclosure relate to the field of communication technologies, and in particular, to a communication method and apparatus.

### BACKGROUND

In communication technologies, to improve reliability of data transmission, a repeated transmission technology may be generally used. However, in some complex environments, an obstacle may exist between a terminal device and a base station. Therefore, even if the repeated transmission technology is used, reliability of data transmission may fail to be ensured. Therefore, how to improve reliability of data transmission when an obstacle exists becomes an urgent problem to be resolved currently.

### SUMMARY

This disclosure provides a communication method and apparatus, to improve reliability of data transmission.

According to a first aspect, a communication method is provided. The method may be performed by a first terminal device. The first terminal device may refer to the first terminal device itself, or may refer to a processor, a module, a chip, or a chip system that is in the first terminal device and that implements the method. An example in which the first terminal device performs the communication method is used. In the communication method, the first terminal device may receive first information from a network device, where the first information is used to determine a first resource, the first resource precedes a second resource in time domain, the second resource includes one paging occasion or a plurality of paging occasions, and the plurality of paging occasions are consecutive. The first terminal device enters an idle state or an inactive state. The first terminal device receives a first sequence from the network device on the first resource when a first condition is met. The first sequence is a sequence of a first type. The first condition includes at least one of the following: Signal quality measured by the first terminal device is less than or equal to a first threshold, and signal quality measured by the first terminal device within a first time period is less than or equal to the first threshold. In this way, the first terminal device may output a first prompt signal based on the first sequence.

It can be learned that in the foregoing embodiment, before the first terminal device enters the idle state or the inactive state, the first terminal device may obtain the first resource that precedes the second resource in time domain. The second resource includes one paging occasion or a plurality of paging occasions, and the plurality of paging occasions are consecutive. In this way, when the first terminal device enters the idle state or the inactive state, the first terminal device that is obstructed (for example, the first condition is met) may receive the sequence of the first type, for example, the first sequence, from the network device on the first resource, so that the first prompt signal may be output based on the first sequence. In other words, the sequence has low channel requirements. Therefore, when the first terminal device is obstructed, it can still be ensured that the first terminal device can obtain the sequence of the first type, so that it can be ensured that the first terminal device can output the first prompt signal before the paging occasion arrives. In this way, reliable transmission of the sequence of the first type is ensured, and further, when the first terminal device is obstructed, a user may be notified of upcoming paging via the first prompt signal. This is conducive to improving reliability of paging the first terminal device.

With reference to the first aspect, optionally, that the first terminal device receives the first information from the network device includes: The first terminal device receives a radio resource control (RRC) configuration message from the network device, where the RRC configuration message includes the first information; or the first terminal device receives a connection release message from the network device, where the connection release message includes the first information.

With reference to the first aspect, optionally, the first resource is used by one or more terminal devices to receive the sequence of the first type, and the one or more terminal devices include the first terminal device.

It can be learned that in the foregoing embodiment, resources can be saved when a plurality of terminal devices (including the first terminal device) receive the sequence of the first type using a same resource. When the plurality of terminal devices receive the sequence of the first type using different resources, it is equivalent to that a dedicated resource for receiving the sequence of the first type is configured for each terminal device. This can ensure that the sequence can be obtained when an obstacle exists, so that it can be ensured that these terminal devices can output the first prompt signal before the paging occasion arrives. This is conducive to improving reliability of paging the terminal devices.

With reference to the first aspect, optionally, that the first information is used to determine the first resource includes: The first information includes a resource index of the first resource. The method further includes: The first terminal device obtains identification information of a cell managed by the network device and a position of the one or more paging occasions. The first terminal device generates a second sequence based on the identification information of the cell, the position of the one or more paging occasions, and the resource index of the first resource. That the first terminal device outputs the first prompt signal based on the first sequence includes: The first terminal device outputs the first prompt signal when the first sequence is the same as the second sequence.

It can be learned that in the foregoing embodiment, when the first sequence obtained by the first terminal device from the network device is the same as the second sequence generated by the first terminal device, the first terminal device may output the first prompt signal, thereby reducing likelihood that the first terminal device outputs the first prompt signal after receiving the sequence by mistake. Therefore, this reduces the probability of a false alarm.

With reference to the first aspect, optionally, that the first terminal device generates the second sequence based on the identification information of the cell managed by the network device, the position of the one or more paging occasions, and the resource index of the first resource includes: The first terminal device receives second information from the network device, where the second information indicates a sequence index of the first sequence. The first terminal device generates the second sequence based on the identification information of the cell, the position of the one or more paging occasions, the resource index of the first resource, and the sequence index of the first sequence.

It can be learned that in the foregoing embodiment, the first terminal device generates the second sequence further with reference to the sequence index of the first sequence. In this way, uniqueness of the second sequence can be ensured, and a problem that another terminal device also determines that the first sequence is the same as a sequence generated by the first terminal device is reduced.

With reference to the first aspect, optionally, that the first terminal device outputs the first prompt signal when the first sequence is the same as the second sequence includes: The first terminal device outputs the first prompt signal when there are a plurality of second sequences and the first sequence is the same as any one of the plurality of second sequences.

It can be learned that in the foregoing embodiment, the first terminal device may output the first prompt signal when the first sequence is the same as any one of the plurality of second sequences. In this way, the probability that the first terminal device can output the first prompt signal before the paging occasion arrives is increased, so that when the first terminal device is obstructed, the user can be better notified of upcoming paging, thereby improving reliability of paging the first terminal device.

With reference to the first aspect, optionally, the method further includes: The first terminal device receives a paging message from the network device on the second resource when detecting that the position of the first terminal device changes, where the paging message includes an identifier of the first terminal device.

It can be learned that in the foregoing embodiment, the first terminal device may receive the paging message from the network device on the second resource when detecting that the position of the first terminal device changes. In other words, when the first terminal device is adjusted from being obstructed to being not obstructed, the first terminal device can successfully receive the paging message, thereby ensuring reliability of paging the first terminal device.

With reference to the first aspect, optionally, the method further includes: The first terminal device receives third information from the network device, where the third information is used to determine a third resource, the third resource precedes the second resource in time domain, the third resource is used by a plurality of terminal devices to receive a sequence of a second type, and the plurality of terminal devices include the first terminal device. The first terminal device enters the idle state or the inactive state, and the first terminal device receives a third sequence from the network device on the third resource when the first condition is met, where the third sequence is a sequence of the second type. The first terminal device outputs a second prompt signal based on the third sequence.

It can be learned that in the foregoing embodiment, before the first terminal device enters the idle state or the inactive state, the first terminal device may obtain the third resource that precedes the second resource in time domain. The third resource is used by the plurality of terminal devices (including the first terminal device) to receive the sequence of the second type. In other words, the network device configures a same resource for different terminal devices to receive the sequence of the second type. This saves resources, and further better avoids the sequence of the first type, thereby reducing interference. Further, when the first terminal device enters the idle state or the inactive state, the first terminal device that is obstructed (for example, the first condition is met) may receive the sequence of the second type, for example, the third sequence, from the network device on the third resource, so that the second prompt signal may be output based on the third sequence. In other words, the sequence has low channel requirements. Therefore, when the first terminal device is obstructed, it can still be ensured that the first terminal device can obtain the sequence of the second type, so that it can be ensured that the first terminal device can output the second prompt signal before the paging occasion arrives. In this way, the reliable transmission of the sequence of the second type is ensured, and further, when the first terminal device is obstructed, the user may be notified of emergency information via the second prompt signal.

With reference to the first aspect, optionally, that the third information is used to determine the third resource includes: The third information includes a resource index of the third resource. The method further includes: The first terminal device generates a fourth sequence based on the identification information of the cell managed by the network device, the position of the one or more paging occasions, and the resource index of the third resource. That the first terminal device outputs the second prompt signal based on the third sequence includes: The first terminal device outputs the second prompt signal when the third sequence is the same as the fourth sequence.

It can be learned that in the foregoing embodiment, when the third sequence obtained by the first terminal device from the network device is the same as the fourth sequence generated by the first terminal device, the first terminal device may output the second prompt signal, thereby reducing likelihood that the first terminal device outputs the prompt signal after receiving the sequence by mistake. Therefore, this reduces the probability of a false alarm.

According to a second aspect, a communication method is provided. The method may be performed by a network device. The network device may refer to the network device itself, or may refer to a processor, a module, a chip, or a chip system that is in the network device and that implements the method. An example in which the network device performs the communication method is used. In the communication method, the network device transmits first information to a first terminal device, where the first information is used to determine a first resource, the first resource precedes a second resource in time domain, the second resource includes one paging occasion or a plurality of paging occasions, and the plurality of paging occasions are consecutive. The network device transmits a first sequence to the first terminal device on the first resource, where the first sequence is a sequence of a first type. The first sequence is a sequence received when a first condition is met after the first terminal device enters an idle state or an inactive state, and the first condition includes at least one of the following: Signal quality measured by the first terminal device is less than or equal to a first threshold, and signal quality measured by the first terminal device within a first time period is less than or equal to the first threshold. The first sequence is used by the first terminal device to output a first prompt signal.

It can be learned that in the foregoing embodiment, the network device may transmit the first information to the first terminal device, so that before the first terminal device enters the idle state or the inactive state, the first terminal device may obtain the first resource that precedes the second resource in time domain. The second resource includes one paging occasion or a plurality of paging occasions, and the plurality of paging occasions are consecutive. In this way, when the first terminal device enters the idle state or the inactive state, the first terminal device that is obstructed (for example, the first condition is met) may receive the sequence of the first type, for example, the first sequence, from the network device on the first resource, so that the first prompt signal may be output based on the first sequence. In other words, the sequence has low channel requirements. Therefore, when the first terminal device is obstructed, it can still be ensured that the first terminal device can obtain the sequence of the first type, so that it can be ensured that the first terminal device can output the first prompt signal before the paging occasion arrives. In this way, reliable transmission of the sequence of the first type is ensured, and further, when the first terminal device is obstructed, a user is notified of upcoming paging via the first prompt signal. This is conducive to improving reliability of paging the first terminal device.

With reference to the second aspect, optionally, that the network device transmits the first information to the first terminal device includes: The network device transmits an RRC configuration message to the first terminal device, where the RRC configuration message includes the first information; or the network device transmits a connection release message to the first terminal device, where the connection release message includes the first information.

With reference to the second aspect, optionally, the first resource is used by one or more terminal devices to receive the sequence of the first type, and the one or more terminal devices include the first terminal device.

It can be learned that in the foregoing embodiment, resources can be saved when a plurality of terminal devices (including the first terminal device) receive the sequence of the first type using a same resource. When the plurality of terminal devices receive the sequence of the first type using different resources, it is equivalent to that a dedicated resource for receiving the sequence of the first type is configured for each terminal device. This can ensure that the sequence can be obtained when an obstacle exists, so that it can be ensured that these terminal devices can output the first prompt signal before the paging occasion arrives. This is conducive to improving reliability of paging the terminal devices.

With reference to the second aspect, optionally, that the network device transmits the first sequence to the first terminal device on the first resource includes: When there are a plurality of first sequences, the network device transmits any one of the plurality of first sequences to the first terminal device on the first resource.

It can be learned that in the foregoing embodiment, the network device may transmit any one of the plurality of first sequences to the first terminal device, which is more flexible.

With reference to the second aspect, optionally, the method further includes: The network device transmits third information to the first terminal device, where the third information is used to determine a third resource, the third resource precedes the second resource in time domain, the third resource is used by a plurality of terminal devices to receive a sequence of a second type, and the plurality of terminal devices include the first terminal device. The network device transmits a third sequence to the first terminal device on the third resource, where the third sequence is the sequence of the second type. The third sequence is a sequence received when the first condition is met after the first terminal device enters the idle state or the inactive state. The third sequence is used by the first terminal device to output a second prompt signal.

It can be learned that in the foregoing embodiment, the network device may transmit the third information to the first terminal device, so that before the first terminal device enters the idle state or the inactive state, the first terminal device may obtain the third resource that precedes the second resource in time domain. The third resource is used by the plurality of terminal devices (including the first terminal device) to receive the sequence of the second type. In other words, the network device configures a same resource for different terminal devices to receive the sequence of the second type. This saves resources, and further better avoids the sequence of the first type, thereby reducing interference. Further, when the first terminal device enters the idle state or the inactive state, the first terminal device that is obstructed (for example, the first condition is met) may receive the sequence of the second type, for example, the third sequence, from the network device on the third resource, so that the second prompt signal may be output based on the third sequence. In other words, the sequence has low channel requirements. Therefore, when the first terminal device is obstructed, it can still be ensured that the first terminal device can obtain the sequence of the second type, so that it can be ensured that the first terminal device can output the second prompt signal before the paging occasion arrives. In this way, reliable transmission of the sequence of the second type is ensured, and further, when the first terminal device is obstructed, the user is notified of emergency information via the second prompt signal.

According to a third aspect, a communication apparatus is provided, including units or modules configured to implement the method according to any one of the embodiments of the first aspect or the second aspect. The communication apparatus may be a terminal device (for example, a first terminal device) or a network device, or may be a terminal device (for example, a first terminal device) or a module (for example, a processor, a chip, or a chip system) of a network device, or may be a logical node, a logical module, or software that can implement all or some functions of a terminal device (for example, a first terminal device) or a network device.

According to a fourth aspect, a communication apparatus is provided. The communication apparatus includes at least one processor. The at least one processor is configured to perform the method according to any one of the embodiments of the first aspect or the second aspect. The communication apparatus may be a terminal device (for example, a first terminal device) or a network device, or may be a terminal device (for example, a first terminal device) or a module (for example, a processor, a chip, or a chip system) of a network device, or may be a logical node, a logical module, or software that can implement all or some functions of a terminal device (for example, a first terminal device) or a network device. The at least one processor may execute a computer program or instructions in a memory, so that the foregoing method is performed. The memory may be included in the communication apparatus, or may be located outside the communication apparatus. In addition, the communication apparatus may further include an interface.

According to a fifth aspect, a communication system is provided. The communication system includes a terminal device and a network device. The terminal device is configured to perform the method according to any one of the embodiments of the first aspect, and the network device is configured to perform the method according to any one of the embodiments of the second aspect.

According to a sixth aspect, a computer-readable storage medium is provided. The computer-readable storage medium stores computer instructions. When the computer instructions are executed, a computer is caused to perform the method according to any one of the embodiments of the first aspect or the second aspect.

According to a seventh aspect, a computer program product is provided. The computer program product includes computer program code. When the computer program code is run by a computer, the computer is caused to perform the method according to any one of the embodiments of the first aspect or the second aspect.

According to an eighth aspect, a chip is provided. The chip includes at least one processor and an interface. The processor is configured to read and execute instructions stored in a memory. When the instructions are run, the chip is caused to perform the method according to any one of the embodiments of the first aspect or the second aspect.

### BRIEF DESCRIPTION OF DRAWINGS

The following briefly describes accompanying drawings used in describing embodiments.

FIG. 1 shows a basic architecture of an example communication system according to an embodiment of this disclosure;

FIG. 2-1 to FIG. 2-4 are diagrams of example NTN-device-based RAN architectures to which an embodiment of this disclosure is applicable;

FIG. 3 is a diagram of an example paging occasion;

FIG. 4 is a schematic flowchart of an example communication method according to an embodiment of this disclosure;

FIG. 5 is a diagram of an example resource according to an embodiment of this disclosure;

FIG. 6 is another diagram of an example resource according to an embodiment of this disclosure;

FIG. 7 is a diagram of a structure of an example communication apparatus according to an embodiment of this disclosure; and

FIG. 8 is a diagram of a structure of another example communication apparatus according to an embodiment of this disclosure.

### DESCRIPTION OF EMBODIMENTS

The following describes the technical solutions in embodiments of this disclosure with reference to the accompanying drawings in embodiments of this disclosure. The terms “system” and “network” may be used interchangeably in embodiments of this disclosure. “/” represents an “or” relationship between associated objects unless otherwise specified. For example, A/B may represent A or B. The term “and/or” in this disclosure is merely an association relationship for describing associated objects, and represents that one of three relationships may exist. For example, A and/or B may represent one of the following three cases: Only A exists, both A and B exist, or only B exists, where A and B each may be singular or plural. In addition, in the descriptions of this disclosure, “a plurality of” means two or more than two unless otherwise specified. “At least one of the following items (pieces)” or a similar expression thereof means any combination of these items, including a single item (piece) or any combination of a plurality of items (pieces). For example, at least one of a, b, or c may indicate: a, b, c, a and b, a and c, b and c, or a, b, and c, where a, b, and c may be singular or plural. In addition, to clearly describe the technical solutions in embodiments of this disclosure, the terms such as “first” and “second” are used in embodiments of this disclosure to distinguish between same items or similar items that provide basically same network elements and purposes. A person skilled in the art may understand that the terms such as “first” and “second” do not limit a quantity or an execution sequence, and the terms such as “first” and “second” do not indicate a definite difference.

Reference to “an embodiment”, “some embodiments”, or the like described in embodiments of this disclosure means that one or more embodiments of this disclosure include a specific feature, structure, or characteristic described with reference to the embodiments. Therefore, statements such as “in an embodiment”, “in some embodiments”, “in some other embodiments”, and “in other embodiments” that appear at different places in this specification do not necessarily mean referring to a same embodiment. Instead, the statements mean “one or more but not all of embodiments”, unless otherwise specifically emphasized in another manner. The terms “include”, “have”, and their variants all mean “include, but are not limited to”, unless otherwise specifically emphasized in another manner.

The objectives, technical solutions, and beneficial effects of this disclosure are further described in detail in the following embodiments. It should be understood that the following descriptions are merely specific embodiments of this disclosure, but are not intended to limit the scope of protection of this disclosure. Any modification, equivalent replacement, improvement, or the like made based on the technical solutions of this disclosure shall fall within the scope of protection of this disclosure.

In embodiments of this disclosure, unless otherwise stated or there is a logic conflict, terms and/or descriptions in different embodiments are consistent and may be mutually referenced, and technical features in different embodiments may be combined based on an internal logical relationship thereof, to form a new embodiment.

It should be understood that the technical solutions of this disclosure may be applied to a non-terrestrial network (NTN) or a scenario in which an NTN and a terrestrial network (TN) are integrated. The technical solutions of this disclosure may use an access technology evolved after 5G, for example, a long term evolution (LTE) access technology, a 5^{th} generation mobile communication (5G) access technology, or a 6^{th} generation mobile communication (6G) access technology.

The following describes a basic architecture of a communication system provided in embodiments of this disclosure. The communication system provided in this disclosure may include one or more network devices and one or more terminal devices.

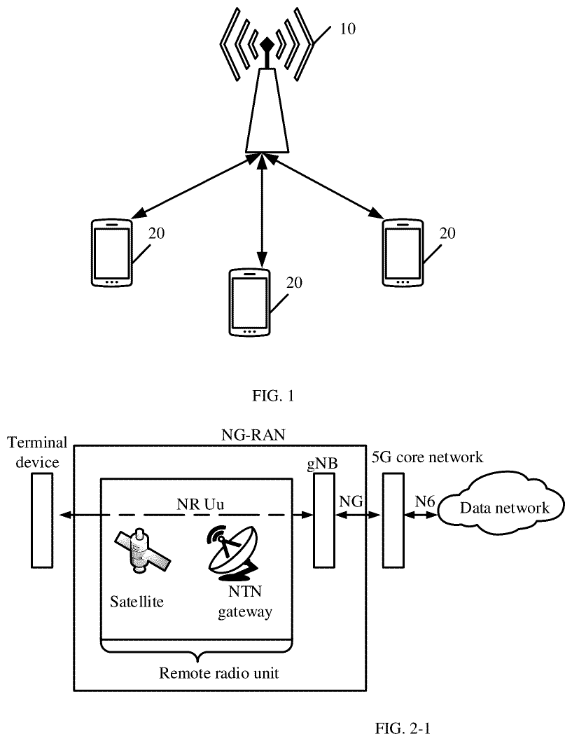

The following uses a system architecture shown in FIG. 1 as an example for description. In FIG. 1, the communication system includes a network device 10 and a terminal device 20 that communicates with the network device 10.

It should be noted that quantities of network devices and terminal devices in FIG. 1 are merely examples, and should not be considered as a specific limitation on this disclosure. The following describes in detail the terminal device and the network device that are related to the system architecture.

### 1. Terminal Device

The terminal device is an entity that is on a user side and that is configured to receive a signal, or transmit a signal, or receive a signal and transmit a signal. The terminal device is configured to provide one or more of a voice service and a data connectivity service for a user. The terminal device may be a device that has a wireless transceiver function and that may cooperate with a network device to provide a communication service for the user. Specifically, the terminal device may be user equipment (UE), an access terminal, a subscriber unit, a subscriber station, a mobile station, a remote station, a remote terminal, a mobile device, a terminal, a wireless communication device, a user agent, a user apparatus, or a road side unit (RSU). The terminal device may alternatively be an uncrewed aerial vehicle, an internet of things (internet of things, IoT) device, a station (ST) in a wireless local area network (WLAN), a cellular phone, a smartphone, a cordless phone, a wireless data card, a tablet computer, a session initiation protocol (SIP) phone, a wireless local loop (WLL) station, a personal digital assistant (PDA) device, a laptop computer, a machine-type communication (MTC) terminal, a handheld device with a wireless communication function, a computing device or another processing device connected to a wireless modem, an in-vehicle device, a wearable device (also referred to as a wearable smart device), a virtual reality (VR) terminal, an augmented reality (AR) terminal, a wireless terminal in telemedicine, a wireless terminal in industrial control, a wireless terminal in self-driving, a wireless terminal in a smart grid, a wireless terminal in transportation safety, a wireless terminal in a smart city, a wireless terminal in a smart home, or the like. The terminal device may alternatively be a terminal in a 5G system, or a terminal in a next-generation communication system. This is not limited in embodiments of this disclosure.

A device form of the terminal device is not limited in embodiments of this disclosure. An apparatus for implementing a function of the terminal device may be a terminal device, or may be an apparatus, for example, a chip system, that can enable the terminal device to implement the function. The apparatus may be mounted in the terminal device or used in a manner of matching the terminal device. In this embodiment of this disclosure, the chip system may include a chip, or may include a chip and another discrete component.

### 2. Network Device

The network device is an entity that is on a network side and that is configured to transmit a signal, or receive a signal, or transmit a signal and receive a signal. The network device may be an apparatus deployed in a radio access network (RAN) to provide a wireless communication function for the terminal device.

In a possible scenario, the network device may be a device having a base station function, for example, an evolved NodeB (eNodeB), a transmission reception point (TRP), a transmission point (TP), a next-generation NodeB (gNB), a next-generation base station in a 6G mobile communication system, an integrated access and backhaul (IAB) node, or a non-terrestrial network device, that is, a device or a satellite that may be deployed on a high-altitude platform, or the like. The network device may be a transmission reception point (TRP), a base station, or a control node in various forms, for example, a network controller or a wireless controller. Specifically, the network device may be a macro base station in various forms, a micro base station (also referred to as a small cell) in a heterogeneous network (HetNet) scenario, a relay station, an access point (AP), a radio network controller (RNC), a NodeB (NB), a base station controller (BSC), a base transceiver station (BTS), a home NodeB (for example, a home evolved NodeB or a home NodeB, HNB), a baseband unit (BBU) and a remote radio unit (RRU) in a distributed base station scenario, a transmission reception point (TRP), a transmission point (TP), a mobile switching center, or the like, or may be an antenna panel of a base station. The control node may be connected to a plurality of base stations, and configure resources for a plurality of terminals covered by the plurality of base stations. In systems using different radio access technologies, names of devices having a base station function may vary. For example, the device may be a gNB in 5G, a network side device in a network after 5G, a network device in a future evolved public land mobile (communication) network (PLMN) network, or a device having a base station function in device-to-device (D2D) communication, machine-to-machine (M2M) communication, or internet of vehicles communication. A specific name of the network device is not limited in this disclosure. Alternatively, the network device may be an open access network (open RAN, O-RAN, or ORAN), a baseband pool (BBU pool) and an RRU in a cloud radio access network (CRAN), or the like.

In another possible scenario, a plurality of network devices collaborate to assist the terminal device in implementing wireless access, and different network devices separately implement some functions of the base station. For example, the network device may include a central unit (CU), a distributed unit (DU), a CU-control plane (CP), a CU-user plane (UP), a radio unit (RU), or the like. The CU and the DU may be separately arranged, or may be included in a same network element, for example, a baseband unit (BBU). The RU may be included in a radio frequency device or a radio frequency unit, for example, included in a remote radio unit (RRU), an active antenna unit (AAU), or a remote radio head (RRH). It may be understood that the network device may be a CU node, a DU node, or a device including a CU node and a DU node. In addition, the CU may be classified as a network device in an access network RAN, or the CU may be classified as a network device in a core network CN. This is not limited herein.

In different systems, the CU (or the CU-CP and the CU-UP), the DU, or the RU may also have different names, but a person skilled in the art may understand meanings thereof. For example, in an ORAN system, the CU may also be referred to as an O-CU (open CU), the DU may also be referred to as an O-DU, the CU-CP may also be referred to as an O-CU-CP, the CU-UP may also be referred to as an O-CU-UP, and the RU may also be referred to as an O-RU. For ease of description, the CU, the CU-CP, the CU-UP, the DU, and the RU are used as examples for description in this disclosure. Any one of the CU (or the CU-CP or the CU-UP), the DU, and the RU in this disclosure may be implemented by using a software module, a hardware module, or a combination of a software module and a hardware module.

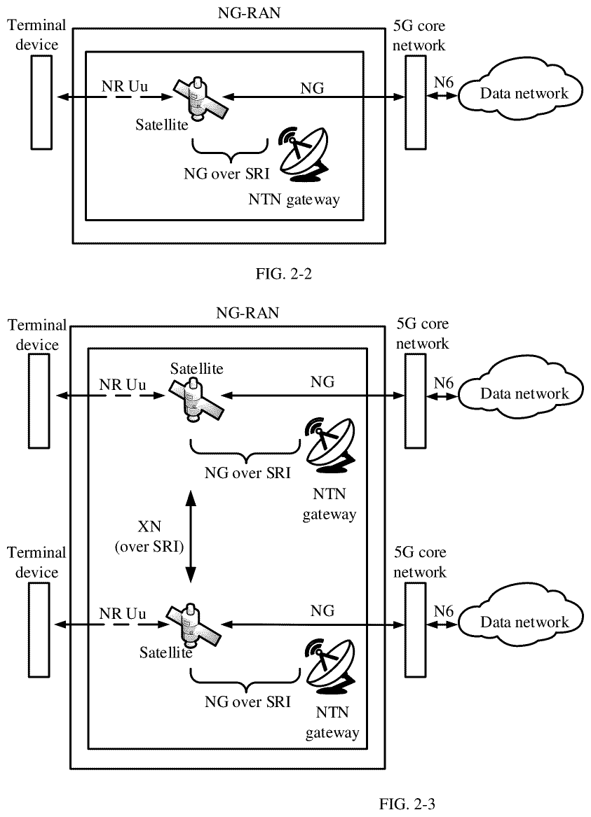

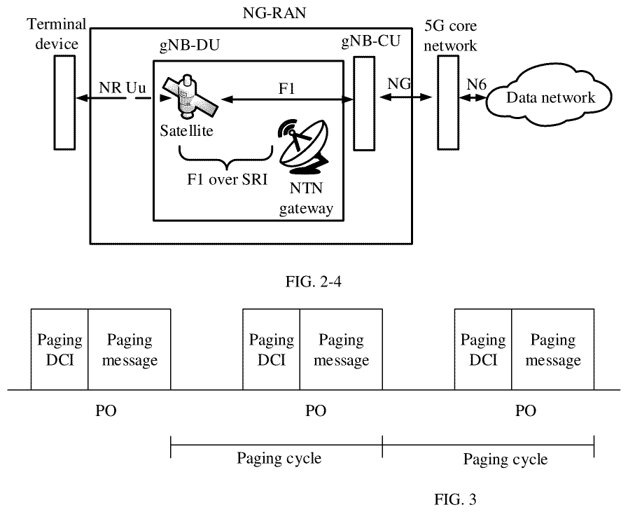

When the network device is a satellite, the satellite may have different functions in different scenarios. Specifically:
1. In a transparent satellite architecture shown in FIG. 2-1, a radio access network (RAN) may include a remote radio unit (RRU) and a base station (for example, a gNB in FIG. 2-1). The RRU may include a satellite and an NTN gateway. The satellite is used for radio frequency filtering and frequency conversion and amplification to ensure that the waveform signal repeated by the payload is un-changed. That is, the satellite is mainly used as a layer 1 (L1 for short) relay device, and is configured to regenerate a physical layer signal (that is, radio frequency filtering, frequency conversion, and amplification), and does not have another higher protocol layer. The NTN gateway supports all the functions of forwarding signals of a new radio-Uu (NR-Uu) interface. The NR-Uu interface is an interface between a terminal device and a base station in a protocol.
2. In a regenerative satellite architecture without inter-satellite links shown in FIG. 2-2, the RAN includes a satellite and an NTN gateway. As a base station, the satellite has the processing functions of the base station. The NTN gateway is a transport network layer node and supports corresponding transport protocols. The satellite is connected to the NTN gateway through a satellite radio interface (SRI). An NG interface is carried over the SRI (NG over SRI) and is responsible for information transmission at a higher layer.
3. In a regenerative satellite architecture with inter-satellite links shown in FIG. 2-3, similar to FIG. 2-2, a difference lies in that an SRI exists, and a plurality of satellites may be connected through an Xn interface. The Xn interface is carried on the SRI (Xn over SRI).
4. In a regenerative satellite architecture with a distributed unit (DU) processing function of a base station shown in FIG. 2-4, a satellite is used as a DU in the base station, and performs a base station function together with a central unit (CU). An NTN gateway exists between the DU on the satellite and the CU on the ground. The NTN gateway is a transport network layer node and supports corresponding transport protocols. The satellite is connected to the NTN gateway through an F1 interface. The F1 interface is carried over the SRI (F1 over SRI).
5. In a satellite architecture with integrated access and backhaul (IAB) functionality, a satellite is used as a base station with IAB functionality.

When the satellite is used as a layer 1 relay device (that is, in a transparent satellite architecture shown in FIG. 2-1), the communication system may further include a base station. The base station may be an evolved universal terrestrial radio access (E-UTRA) system, an NR system, or a future radio access system defined in the 3^{rd} generation partnership project (3GPP), or may be a Wi-Fi system, or may be enhanced mobile broadband (eMBB), ultra-reliable and low latency communication (URLLC), and massive machine-type communications (mMTC), a long range internet of things (LoRa) system, or an internet of vehicles system. The base station may further include two or more foregoing different radio access systems. The base station may alternatively be an open radio access network (RAN) (open RAN, O-RAN).

In this disclosure, the satellite may be, for example, a medium earth orbit (MEO) satellite, a low earth orbit (LEO) satellite, a high-altitude platform station (HAPS), an evolved NodeB (eNB), or a 5G NodeB (gNB) in a non-geostationary orbit (NGEO).

A form of the network device is not limited in embodiments of this disclosure. An apparatus for implementing a function of the network device may be a network device, or may be an apparatus, for example, a chip system, that can enable the network device to implement the function. The apparatus may be mounted in the network device or used together with the network device.

To facilitate understanding of content of the solutions, the following further explains and describes some terms in embodiments of this disclosure, so as to facilitate understanding by a person skilled in the art. This part is merely for ease of understanding, and cannot be considered as a specific limitation on this disclosure.

### 1. Paging

A paging technology is an important technology in a wireless communication system. A network device may find a terminal device through paging, and initiate a service for the terminal device. When the terminal device is in an idle state (idle) or an inactive state (inactive), the network device knows a tracking area (TA) in which the terminal device is located. Therefore, when needing to search for a terminal device, the network device needs to first check a TA to which the terminal device belongs, and then transmit a paging message to all cells in the TA. The paging process may be understood as a process of establishing or resuming an RRC connection between the terminal device and the network device.

The paging may include downlink data paging, system information change paging, or natural disaster public safety paging. The natural disaster public safety paging may include at least one of earthquake and tsunami warning system (ETWS) paging, commercial mobile alert system (CMAS) paging, or the like.

The idle state may also be referred to as an RRC idle state. When the terminal device is in the idle state, the terminal device does not retain an RRC context. The RRC context is a parameter for establishing communication between the terminal device and the network device. The RRC context may include a security context, capability information of the terminal device, and the like. In addition, the terminal device does not establish a connection to a core network device. That is, the core network device is in a CN_IDLE state (core network idle state). The terminal device does not have data to be transmitted, enters a sleep state, and turns off a transceiver unit to reduce power consumption. The terminal device in the idle state only periodically wakes up to receive the paging message.

The inactive state may also be referred to as an RRC inactive state, a deactivated state, or an RRC deactivated state. When the terminal device is in the inactive state, an RRC context is retained between the terminal device and the network device. In addition, the terminal device also establishes a connection to the core network device. That is, the core network device is in a CN_CONNECTED state (core network connected state). In this case, a procedure of switching to the connected state to receive data is relatively fast, and no additional core network signaling overheads are generated. In addition, the terminal device in the inactive state also enters a sleep state. Therefore, the inactive state can meet requirements of reducing a connection latency, signaling overheads, and power consumption.

### 2. Paging Occasion (PO)

A position of paging downlink control information (DCI) and/or a position of a paging message are/is referred to as a paging occasion. FIG. 3 is a diagram of a paging occasion. As shown in FIG. 3, a paging occasion within a paging cycle may include a time domain position in which paging DCI is located and a time domain position in which a paging message is located. The terminal device may calculate a paging occasion based on a related parameter (for example, identification information and a paging parameter that is provided by a system message), to receive the paging DCI and the paging message on a corresponding paging occasion.

The paging DCI is used to schedule the paging message. To be specific, the paging DCI indicates a time-frequency resource of the paging message. After receiving the paging DCI, the terminal device may receive the paging message based on the time-frequency resource indicated by the paging DCI. The paging message is carried on a paging physical downlink shared channel (paging PDSCH), and is used to page the terminal device. The paging message includes an identifier of a paged terminal device. In other words, if an identifier of a terminal device is carried in the paging message, it indicates that the terminal device is paged by a network device. The identifier of the terminal device may include one or more of the following: a system architecture evolution temporary subscriber identity (S-TMSI), a globally unique temporary identity (GUTI), a subscription permanent identifier (SUPI), an radio network temporary identifier (RNTI), or the like. This is not limited herein.

Optionally, the terminal device may receive the paging message on one paging occasion or a plurality of paging occasions, and the plurality of paging occasions may be consecutive. In other words, paging cycles in which all of the plurality of paging occasions are located are consecutive. The plurality of consecutive paging occasions may be referred to as a paging occasion group.

Optionally, within the paging cycle, one paging occasion is used by the terminal device to receive the paging message.

### 3. Sequence

The sequence described in this disclosure may be a pseudorandom sequence, for example, a Zadoff-Chu (ZC) sequence, a Gold sequence, or a Hadamard code sequence.

Optionally, one or more pseudorandom sequences may be provided. In other words, the sequence described in this disclosure may include one or more pseudorandom sequences. For example, a sequence may include a ZC sequence and a Gold sequence, or the sequence may include a ZC sequence and a Hadamard sequence.

Optionally, the sequence described in this disclosure may be classified into a sequence of a first type and a sequence of a second type.

The sequence of the first type is used to output a first prompt signal. The first prompt signal may have at least one of the following embodiments, which are specifically:
1. The first prompt signal indicates a user to adjust the position of a terminal device.
2. The first prompt signal is used to notify the user of an upcoming paging message.

The sequence of the second type is used to output a second prompt signal. The second prompt signal is used to notify the user of emergency information, for example, natural disaster public safety paging.

Optionally, prompt information (for example, the first prompt signal or the second prompt signal) described in this disclosure may be at least one of a sound, vibration, or a text.

Optionally, the sequence described in this disclosure may be uniquely identified using a sequence index. The sequence index of the sequence may alternatively have another name, for example, an identifier of the sequence or a number of the sequence. This is not limited in this disclosure.

### 4. Resource

The resource described in this disclosure may be a time domain resource and/or a frequency domain resource. Optionally, the time domain resource and the frequency domain resource may also be referred to as a time-frequency resource.

The time domain resource may include, for example, at least one of the following: a frame, a subframe, a slot, a symbol, and the like. In NR, duration of a frame is 10 milliseconds (ms), each frame is divided into 10 subframes, and a length of each subframe is 1 ms. Each subframe is divided into several slots. When a cyclic prefix (CP) is a normal cyclic prefix (NCP), each slot includes 14 symbols. When a cyclic prefix is an extended cyclic prefix (ECP), each slot includes 12 symbols. Certainly, with the evolution of communication technologies, compositions of a frame, a subframe, a slot, and a symbol may be different, or may be referred to as other names. This is not limited in this disclosure. It should be noted that the symbol in this disclosure may be an orthogonal frequency-division multiplexing (OFDM) symbol.

The frequency domain resource may include, for example, at least one of the following: a subcarrier, a resource block (RB), a resource block group (RBG), a sub-channel, a bandwidth part (BWP), and a carrier. One resource block is a plurality of contiguous subcarriers in frequency domain. For example, one resource block may include 12 subcarriers. A plurality of resource blocks may form one resource block group. The carrier is a contiguous frequency range that complies with a system specification. The frequency range may be determined based on a center frequency (denoted as a carrier frequency) of the carrier and a bandwidth of the carrier. One carrier may include one bandwidth part. One bandwidth part may include one or more sub-channels, and one sub-channel includes a plurality of resource blocks. The sub-channel may also be referred to as a sub-band.

Optionally, the resource used to receive a sequence (for example, the sequence of the first type or the sequence of the second type) may further include a code domain resource. The code domain resource indicates a parameter of the sequence.

For example, the sequence is a ZC sequence or a Hadamard sequence, and a parameter of the sequence includes at least one of the following: a root index, a mask, a scrambling code, a cyclic shift (CS), an orthogonal cover code (OCC), and the like.

For another example, the sequence is a Gold sequence, and a parameter of the sequence includes at least one of the following: a length of the sequence, an initial value of the sequence, and the like.

It should be noted that the foregoing is merely some examples, and the foregoing examples may be combined. Details are not listed one by one herein.

Optionally, a resource used to receive the sequence of the first type may be referred to as a paging notification resource (PNR), and a resource used for receiving the sequence of the second type may be referred to as a common PNR. A name of the resource is not limited in this disclosure.

Optionally, the resource described in this disclosure may be uniquely identified using a resource index. The resource index of the resource may have another name, for example, an identifier of the resource or a number of the resource. This is not limited in this disclosure.

### 5. Signal Quality

The signal quality in this disclosure is a result obtained by measuring signal quality or signal energy based on a reference signal, for example, one or more of a reference signal received power (RSRP), a reference signal received quality (RSRQ), a received signal strength indicator (RSSI), and a signal to interference plus noise ratio (SINR).

The reference signal may include at least one of the following: a synchronization signal block (SSB), a channel state information reference signal (CSI-RS), a demodulation reference signal (DMRS), and the like.

Generally, the terminal device may measure a reference signal from the network device, to obtain signal quality. The measurement may also be described as evaluation, detection, estimation, or the like. Optionally, magnitudes of signal quality measured by the terminal device at different moments may be the same or different.

Currently, to improve the reliability of paging, a repeated transmission technology or DMRS bundling may be generally used. However, in some complex environments, an obstacle may exist between a terminal device and a base station. Therefore, even if the repeated transmission technology or DMRS bundling is used, reliability of paging may fail to be ensured. Therefore, how to improve reliability of paging the terminal device when an obstacle exists becomes an urgent problem to be resolved in a current phase. In view of this, this disclosure provides a communication method, to resolve this problem.

The following describes embodiments of this disclosure in detail. Specifically, a first terminal device in the following may be the terminal device in FIG. 1, and a network device in the following may be the network device in FIG. 1. It should be noted that names of messages between network elements, names of parameters in the messages, or the like in the following embodiments are merely examples, and there may be other names in an example embodiment. This is not specifically limited in embodiments of this disclosure. Processing performed by a single execution body (the first terminal device or the network device) shown in embodiments of this disclosure may alternatively be performed by a plurality of execution bodies. These execution bodies may be logically and/or physically separated. For example, processing performed by the network device may be performed by at least one of a CU, a DU, and an RU.

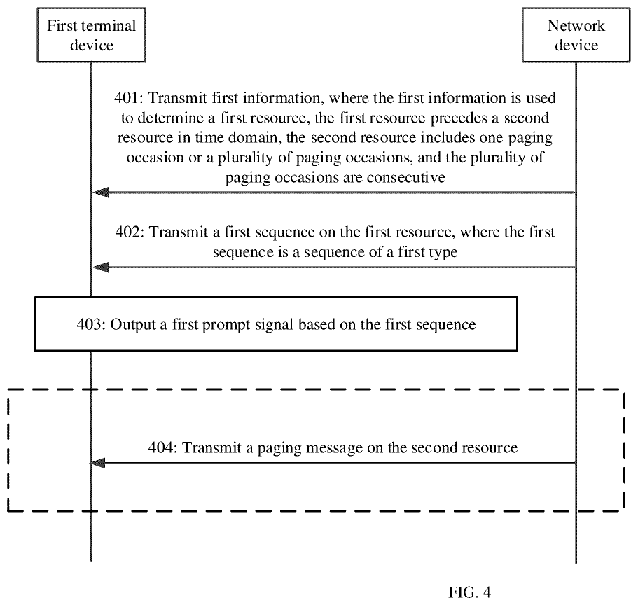

FIG. 4 shows a communication method according to an embodiment of this disclosure. The communication method includes, but is not limited to, the following steps.

401: A network device transmits first information to a first terminal device, where the first information is used to determine a first resource, the first resource precedes a second resource in time domain, the second resource includes one paging occasion or a plurality of paging occasions, and the plurality of paging occasions are consecutive.

Correspondingly, the first terminal device receives the first information from the network device.

The network device may transmit the first information to the first terminal device in any one of the following manners. Specifically:
1. The network device transmits an RRC configuration message to the first terminal device, where the RRC configuration message includes the first information. The RRC configuration message may be an RRC reconfiguration message, a downlink information transfer (DL information transfer) message, an RRC setup complete message, or the like.
2. The network device transmits a connection release message to the first terminal device, where the connection release message includes the first information. In this case, the first terminal device enters an idle state. The connection release message may be an RRC release message.

Optionally, that the first information is used to determine the first resource includes: The first information includes a resource index of the first resource.

Optionally, the resource index of the first resource is in a one-to-one correspondence with the first resource. The one-to-one correspondence (that is, a one-to-one correspondence between the resource index of the first resource and the first resource) may be predefined or preconfigured, or the one-to-one correspondence may be indicated by the network device to one or more terminal devices, and the one or more terminal devices include the first terminal device. In this way, when learning the resource index of the first resource, the terminal device may determine, with reference to the one-to-one correspondence, a resource used to receive a sequence of a first type.

When the one-to-one correspondence is indicated by the network device to the terminal device (for example, the first terminal device), the one-to-one correspondence and the resource index of the first resource may be simultaneously transmitted or separately transmitted to the terminal device. For example, the one-to-one correspondence and the first information are located in a same RRC configuration message or connection release message. For another example, the one-to-one correspondence and the first information are located in different RRC configuration messages.

Optionally, a plurality of terminal devices (including the first terminal device) may be, for example, all terminal devices or some terminal devices in a cell managed by the network device.

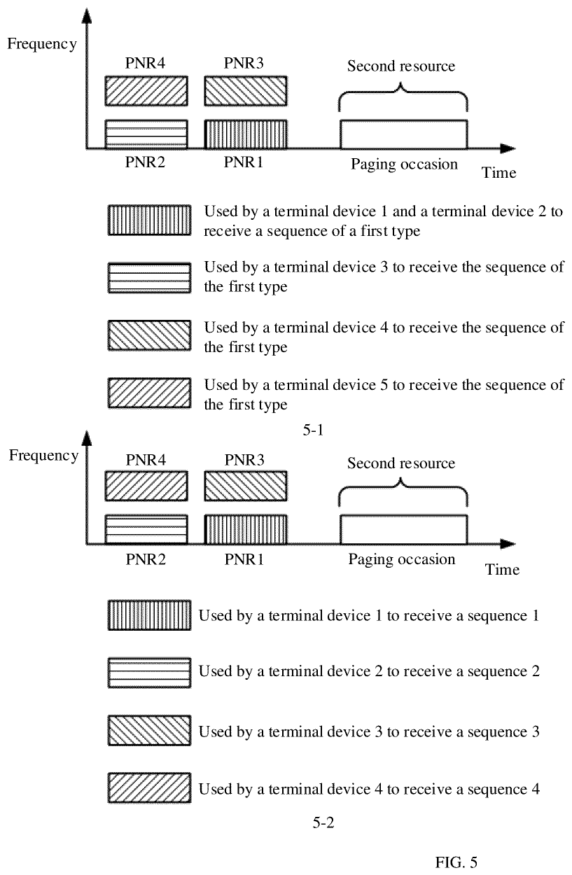

For example, in 5-1 of FIG. 5, the terminal devices in the cell managed by the network device include a terminal device 1 to a terminal device 5. The plurality of terminal devices include the terminal device 1 and the terminal device 2. To be specific, the plurality of terminal devices are some terminal devices in the cell managed by the network device. Resources used by the terminal device 1 and the terminal device 2 to receive the sequence of the first type are both PNR1. Resources used by the terminal device 3 and the terminal device 5 to receive the sequence of the first type are PNR2 and PNR4, respectively. It can be learned that the terminal device 1 and the terminal device 2 use the same resource to receive the sequence of the first type. In addition, PNR1 to PNR4 all precede the second resource in time domain.

For another example, in 5-2 of FIG. 5, the terminal devices in the cell managed by the network device include a terminal device 1 to a terminal device 4. The plurality of terminal devices include the terminal device 1 to the terminal device 4. To be specific, the plurality of terminal devices are all the terminal devices in the cell managed by the network device. Resources used by the terminal device 1 to the terminal device 4 to receive the sequence of the first type are PNR1 to PNR4, respectively. It can be learned that the resources used by the terminal device 1 to the terminal device 4 to receive the sequence of the first type are different. In addition, PNR1 to PNR4 all precede the second resource in time domain.

Optionally, the network device may manage one or more cells. The cell managed by the network device may alternatively be understood as: a cell covered by the network device, a cell managed by the network device, a cell that belongs to the network device, or the like.

Optionally, when the network device configures different resources for different terminal devices in the plurality of terminal devices to receive the sequence of the first type, resources configured by the network device for the plurality of terminal devices may belong to a resource group. In other words, different resources in the resource group are used by different terminal devices to receive the sequence of the first type. The resources in the resource group all precede the second resource in time domain.

Optionally, one or more resource groups may be provided. This is not limited herein.

For example, quantities of resources included in different resource groups may be completely the same, partially the same, or completely different. For example, it is assumed that there are three resource groups, namely, a resource group 1 to a resource group 3. Each of the resource group 1 to the resource group 3 includes two resources, that is, quantities of resources included in different resource groups are the same. Alternatively, each of the resource group 1 and the resource group 2 includes two resources, and the resource group 3 includes four resources, that is, some resource groups in different resource groups include a same quantity of resources. Alternatively, the resource group 1 to the resource group 3 include two resources, four resources, and five resources, respectively, that is, quantities of resources included in different resource groups are completely different.

For another example, different resource groups are used by different terminal device groups to receive the sequence of the first type. For example, it is assumed that there are three resource groups, namely, a resource group 1 to a resource group 3. The resource group 1 to the resource group 3 are used by a terminal device group 1 to a terminal device group 3 respectively to receive the sequence of the first type. Two resources in the resource group 1 are used by two terminal devices in the terminal device group 1 respectively to receive the sequence of the first type. Three resources in the resource group 2 are used by three terminal devices in the terminal device group 2 respectively to receive the sequence of the first type. Three resources in the resource group 3 are used by three terminal devices in the terminal device group 3 respectively to receive the sequence of the first type.

Optionally, that the second resource includes one or more paging occasions may be understood as that a time domain resource of the second resource includes one or more paging occasions.

402: The network device transmits a first sequence to the first terminal device on the first resource, where the first sequence is a sequence of a first type.

Correspondingly, the first terminal device enters the idle state or an inactive state, and the first terminal device receives the first sequence from the network device on the first resource when a first condition is met. The first condition includes at least one of the following: Signal quality measured by the first terminal device is less than or equal to a first threshold, and signal quality measured by the first terminal device within a first time period is less than or equal to the first threshold.

Generally, the network device may page the first terminal device, or may not page the first terminal device. Therefore, before the network device pages the first terminal device, the network device may transmit the first sequence on the first resource. When the network device does not page the first terminal device, the network device may schedule the first resource to transmit downlink data.

Optionally, that the signal quality measured by the first terminal device is less than or equal to the first threshold may be understood as one of the following:
1. After the first terminal device enters the idle state or the inactive state, signal quality measured by the first terminal device at a moment is less than or equal to the first threshold. A moment at which the first terminal device starts to measure signal quality is earlier than a moment at which the first terminal device detects the first sequence. Optionally, the first threshold may be a predefined or preconfigured value greater than or equal to 0, or the first threshold may be indicated by the network device to the first terminal device, or the like.
2. At a moment at which the first terminal device enters the idle state or the inactive state, signal quality measured by the first terminal device at a moment is less than or equal to the first threshold.

The first time period may be a predefined or preconfigured value greater than or equal to 0, or the first time period may be indicated by the network device to the first terminal device, or the like.

Optionally, a start moment of the first time period may be the moment at which the first terminal device enters the idle state or the inactive state. Alternatively, the start moment of the first time period may be any moment after the first terminal device enters the idle state or the inactive state. In this case, the moment at which the first terminal device starts to measure the signal quality is earlier than the moment at which the first terminal device detects the first sequence.

Optionally, when the network device transmits the first information to the first terminal device using the RRC configuration message, the first terminal device is in a connected state. It should be understood that, in some examples, the first terminal device may enter the idle state or the inactive state from the connected state due to some reasons.

For example, when no data is transmitted between the first terminal device and the network device, the first terminal device may receive the connection release message from the network device, to disconnect the first terminal device from the network device. In other words, the first terminal device enters the idle state from the connected state. Optionally, the connection release message may be transmitted by the network device based on a request message from the first terminal device, and the request message is used to request to enter the idle state.

For another example, the network device is a satellite, and the satellite is in a high-speed moving state. Therefore, the time for the satellite to provide a service is limited. In this way, the first terminal device may also be disconnected from the network device, so that the first terminal device enters the idle state from the connected state.

For another example, when a small amount of data is transmitted between the first terminal device and the network device, the first terminal device may enter the inactive state from the connected state.

403: The first terminal device outputs a first prompt signal based on the first sequence.

Optionally, that the first information is used to determine the first resource includes: The first information includes a resource index of the first resource. The method may further include: The first terminal device obtains identification information of a cell managed by the network device and a position of the one or more paging occasions. The first terminal device generates the second sequence based on the identification information of the cell, the position of the one or more paging occasions, and the resource index of the first resource. Step 403 may include: The first terminal device outputs the first prompt signal when the first sequence is the same as the second sequence. In this way, likelihood that the first terminal device outputs the first prompt signal after receiving the sequence by mistake can be reduced. Therefore, this reduces the probability of a false alarm.

The first terminal device may obtain the identification information of the cell using a detected SSB. Optionally, the identification information of the cell may be a physical cell identifier (PCI), a tracking area (TA) identifier, or the like. The tracking area identifier may be a tracking area identity (TAI) or a tracking area code (TAC).

That the first terminal device generates a second sequence based on the identification information of the cell, the position of the one or more paging occasions, and the resource index of the first resource. For example, the second sequence may include a ZC sequence and a Gold sequence. A root index of the ZC sequence is generated based on the identification information of the cell, and an initial value of the Gold sequence is generated based on the position of the one or more paging occasions and the resource index of the first resource.

Optionally, that the first terminal device generates the second sequence based on the identification information of the cell, the position of the one or more paging occasions, and the resource index of the first resource includes: The first terminal device receives second information from the network device, where the second information indicates a sequence index of the first sequence. The first terminal device generates the second sequence based on the identification information of the cell, the position of the one or more paging occasions, the resource index of the first resource, and the sequence index of the first sequence.

For example, the second sequence is a Gold sequence. An initial value of the second sequence is generated based on the identification information of the cell, the position of the one or more paging occasions, the resource index of the first resource, and the sequence index of the first sequence.

For another example, the second sequence is a Gold sequence. An initial value of the second sequence is generated based on the identification information of the cell, the position of the one or more paging occasions, and the resource index of the first resource, and the second sequence is obtained by performing phase shift on the initial value of the second sequence based on the sequence index of the first sequence.

For a manner in which the first terminal device receives the second information, refer to the manner in which the first terminal device receives the first information in step 401. Optionally, the first information and the second information may be located in a same message or different messages. For example, the first information and the second information are located in a same RRC configuration message or different RRC configuration messages. For another example, the first information and the second information are located in a same connection release message.

Optionally, there may be one first sequence or a plurality of first sequences, and sequence indices of the plurality of first sequences are different. In this way, the first terminal device may generate a plurality of second sequences based on the identification information of the cell, the position of the one or more paging occasions, the resource index of the first resource, and the sequence indices of the plurality of first sequences. In an example embodiment, that the first terminal device outputs the first prompt signal when the first sequence is the same as the second sequence may be understood as: The first terminal device outputs the first prompt signal when the first sequence is the same as any one of the plurality of second sequences.

It can be learned from the foregoing content that the network device may allocate a plurality of sequences of the first type to the terminal device. In this case, the network device may transmit any one of the plurality of sequences of the first type to the terminal device. For example, the network device transmits any one of the plurality of first sequences to the first terminal device on the first resource. Optionally, quantities of sequences of the first type allocated to different terminal devices may be the same or different. This is not limited herein.

Optionally, after step 403, step 404 may be further included.

404: The network device transmits a paging message to the first terminal device on the second resource. The paging message includes an identifier of the first terminal device.

Correspondingly, the first terminal device receives the paging message from the network device on the second resource when detecting that the position of the first terminal device changes.

It should be noted that whether the network device transmits the paging message is irrelevant to whether the first terminal device detects the first sequence. In other words, regardless of whether the first terminal device detects the first sequence on the first resource, the network device may transmit the paging message to the first terminal device on the second resource. It may be understood that when the first terminal device does not detect the first sequence on the first resource, if the position of the first terminal device changes and as a result, the first terminal device meets a second condition, the first terminal device may still receive the paging message on the second resource. The second condition includes at least one of the following: the signal quality measured by the first terminal device is greater than or equal to a second threshold, and signal quality measured by the first terminal device within a second time period is greater than or equal to the second threshold.

Optionally, the second threshold may be a predefined or preconfigured value greater than or equal to 0, or the second threshold may be indicated by the network device to the first terminal device, or the like. Similarly, the second time period may be a predefined or preconfigured value greater than or equal to 0, or the second time period may be indicated by the network device to the first terminal device, or the like.

Optionally, the first threshold may be the same as or different from the second threshold, and the first time period may be the same as or different from the second time period. When the first threshold is the same as the second threshold and the first time period is the same as the second time period, “equal to” (for example, the signal quality measured by the first terminal device is equal to the first threshold and the signal quality within the first time period is equal to the first threshold) may be used as an implementation of meeting the first condition, or may be used as an implementation of meeting the second condition.

It can be learned that, in the foregoing embodiment, the sequence has low channel requirements. Therefore, when the first terminal device is obstructed, it can still be ensured that the first terminal device can obtain the sequence of the first type, so that it can be ensured that the first terminal device can output the first prompt signal before the paging occasion arrives. In this way, reliable transmission of the sequence of the first type is ensured, and further, when the first terminal device is obstructed, a user is notified of upcoming paging via the first prompt signal. This is conducive to improving reliability of paging the first terminal device.

Optionally, the method further includes: The first terminal device receives third information from the network device, where the third information is used to determine a third resource, the third resource precedes the second resource in time domain, the third resource is used by a plurality of terminal devices to receive a sequence of a second type, and the plurality of terminal devices include the first terminal device. The first terminal device enters the idle state or the inactive state, and the first terminal device receives a third sequence from the network device on the third resource when the first condition is met, where the third sequence is a sequence of the second type. The first terminal device outputs a second prompt signal based on the third sequence. It can be learned that in the foregoing embodiment, the third resource is used by the plurality of terminal devices (including the first terminal device) to receive the sequence of the second type. In other words, the network device configures a same resource for different terminal devices to receive the sequence of the second type. This saves resources, and further better avoids the sequence of the first type, thereby reducing interference. In addition, the sequence has low channel requirements. Therefore, when the first terminal device is obstructed, it can still be ensured that the first terminal device can obtain the sequence of the second type, so that it can be ensured that the first terminal device can output the second prompt signal before the paging occasion arrives. In this way, reliable transmission of the sequence of the second type is ensured, and further, when the first terminal device is obstructed, the user may be notified of emergency information via the second prompt signal.

For a manner in which the first terminal device receives the third information, refer to the manner in which the first terminal device receives the first information in step 401. In this case, the first information and at least one of the second information and the third information may be located in a same message or different messages.

Optionally, the third information may be carried in a system information block (SIB). In this case, the message in which the third information is located is different from the message in which the second information and the third information are located.

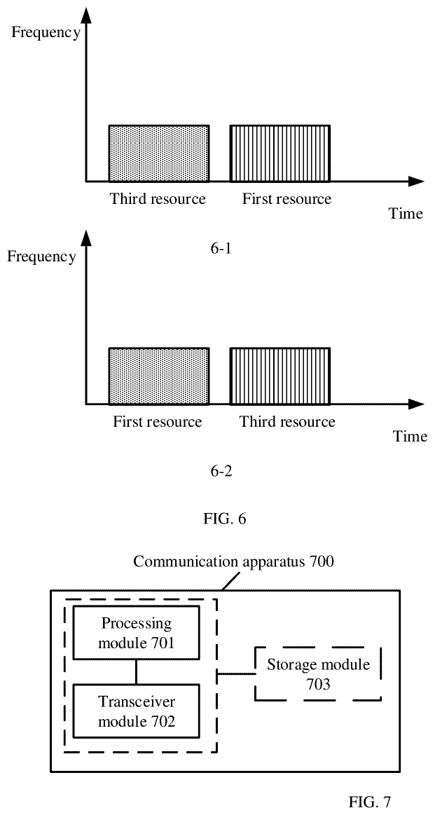

Optionally, the first resource is different from the third resource. In an example embodiment, the third resource may precede the first resource in time domain, as shown in 6-1 of FIG. 6. In another example embodiment, the third resource may follow the first resource in time domain, as shown in 6-2 of FIG. 6.

Optionally, that the third information is used to determine the third resource includes:
the third information includes a resource index of the third resource. The method may further include: The first terminal device generates a fourth sequence based on the identification information of the cell managed by the network device, the position of the one or more paging occasions, and the resource index of the third resource. That the first terminal device outputs the second prompt signal based on the third sequence includes: The first terminal device outputs the second prompt signal when the third sequence is the same as the fourth sequence. In this way, likelihood that the first terminal device outputs the prompt signal after receiving the sequence by mistake can be reduced, so that the probability of a false alarm can be reduced.

For a process in which the first terminal device generates the fourth sequence, refer to the process in which the first terminal device generates the first sequence.

The foregoing mainly describes the solutions provided in this disclosure from the perspective of interaction between devices. It may be understood that, to implement the foregoing functions, each device includes a corresponding hardware structure and/or software module for performing each function. A person skilled in the art should easily be aware that, in combination with units and algorithm steps of the examples described in embodiments disclosed in this specification, this disclosure may be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this disclosure.

In embodiments of this disclosure, the terminal device (for example, the first terminal device) or the network device may be divided into functional modules based on the foregoing method examples. For example, each functional module may be obtained through division based on each corresponding function, or two or more functions may be integrated into one processing module. The integrated module may be implemented in a form of hardware, or may be implemented in a form of a software functional module. It should be noted that, in embodiments of this disclosure, module division is an example, and is merely a logical function division. During actual implementation, another division manner may be used.

FIG. 7 is a diagram of a structure of a communication apparatus according to an embodiment of this disclosure. The communication apparatus 700 may be used in the method shown in the embodiment in FIG. 4. As shown in FIG. 7, the communication apparatus 700 includes a processing module 701 and a transceiver module 702. The processing module 701 may be one or more processors, and the transceiver module 702 may be a transceiver or a communication interface. The communication apparatus may be configured to implement a function of a terminal device (for example, a first terminal device) or the network device in any one of the foregoing method embodiments, or configured to implement a function of a network element in any one of the foregoing method embodiments. The network element or network function may be a network element in a hardware device, a software function running on dedicated hardware, or a virtualized function instantiated on a platform (for example, a cloud platform). Optionally, the communication apparatus 700 may further include a storage module 703, configured to store program code and data of the communication apparatus 700.

In an example, when used as a terminal device (for example, a first terminal device) or a chip used in the terminal device (for example, a first terminal device), the communication apparatus performs the steps performed by the terminal device (for example, a first terminal device) in the foregoing method embodiments. The transceiver module 702 is configured to specifically perform a transmission and/or reception action performed by the terminal device (for example, a first terminal device) in the embodiment in FIG. 4. The processing module 701 may be configured to support the communication apparatus 700 in performing the processing actions in the foregoing method embodiments.

For example, the transceiver module 702 is configured to receive first information from the network device, where the first information is used to determine a first resource, the first resource precedes a second resource in time domain, the second resource includes one paging occasion or a plurality of paging occasions, and the plurality of paging occasions are consecutive. The communication apparatus enters an idle state or an inactive state. When a first condition is met, the transceiver module 702 is configured to receive a first sequence from the network device on the first resource, where the first sequence is a sequence of a first type. The first condition includes at least one of the following: Signal quality measured by a first terminal device is less than or equal to a first threshold, and signal quality measured by the first terminal device within a first time period is less than or equal to the first threshold. The processing module 701 is configured to output a first prompt signal based on the first sequence.

Optionally, when receiving the first information from the network device, the transceiver module 702 is configured to: receive an RRC configuration message from the network device, where the RRC configuration message includes the first information; or receive a connection release message from the network device, where the connection release message includes the first information.

Optionally, that the first information is used to determine the first resource includes:
The first information includes a resource index of the first resource. The transceiver module 702 is configured to obtain identification information of a cell managed by the network device and the position of the one or more paging occasions. The first terminal device generates a second sequence based on the identification information of the cell, the position of the one or more paging occasions, and the resource index of the first resource. When outputting the first prompt signal based on the first sequence, the processing module 701 is configured to output the first prompt signal when the first sequence is the same as the second sequence.

Optionally, when generating the second sequence based on the identification information of the cell managed by the network device, the position of the one or more paging occasions, and the resource index of the first resource, the transceiver module 702 is configured to receive second information from the network device, where the second information indicates a sequence index of the first sequence. The processing module 701 is configured to generate the second sequence based on the identification information of the cell, the position of the one or more paging occasions, the resource index of the first resource, and the sequence index of the first sequence.

Optionally, when the first sequence is the same as the second sequence, when the first prompt signal is output, there are a plurality of second sequences, and when the first sequence is the same as any one of the plurality of second sequences, the processing module 701 is configured to output the first prompt signal.

Optionally, when detecting that the position of the first terminal device changes, the transceiver module 702 is further configured to receive a paging message from the network device on the second resource.

Optionally, the transceiver module 702 is further configured to receive third information from the network device, where the third information is used to determine a third resource, the third resource precedes the second resource in time domain, the third resource is used by a plurality of terminal devices to receive a sequence of a second type, and the plurality of terminal devices include the first terminal device; and when the communication apparatus enters the idle state or the inactive state, when the first condition is met, the transceiver module 702 is further configured to receive the third sequence from the network device on the third resource, where the third sequence is the sequence of the second type. The processing module 701 is further configured to output a second prompt signal based on the third sequence.

Optionally, that the third information is used to determine the third resource includes: the third information includes a resource index of the third resource. The processing module 701 is further configured to: generate a fourth sequence based on the identification information of the cell managed by the network device, the position of the one or more paging occasions, and the resource index of the third resource. When outputting the second prompt signal based on the third sequence, when the third sequence is the same as the fourth sequence, the processing module 701 is configured to output the second prompt signal.

In another example, when the communication apparatus is used as a network device or a chip used in the network device, and performs the steps performed by the network device in the foregoing method embodiments. The transceiver module 702 is configured to specifically perform a transmission and/or reception action performed by the network device in the embodiment in FIG. 4. The processing module 701 may be configured to support the network device in performing the processing actions in the foregoing method embodiments.

For example, the transceiver module 702 is configured to: transmit first information to the first terminal device, where the first information is used to determine a first resource, the first resource precedes a second resource in time domain, the second resource includes one paging occasion or a plurality of paging occasions, and the plurality of paging occasions are consecutive; and transmit a first sequence to the first terminal device on the first resource, where the first sequence is a sequence of a first type. The first sequence is a sequence received when a first condition is met after the first terminal device enters an idle state or an inactive state, and the first condition includes at least one of the following: Signal quality measured by the first terminal device is less than or equal to a first threshold, and signal quality measured by the first terminal device within a first time period is less than or equal to the first threshold. The first sequence is used by the first terminal device to output a first prompt signal.

Optionally, when transmitting the first information to the first terminal device, the transceiver module 702 is configured to: transmit an RRC configuration message to the first terminal device, where the RRC configuration message includes the first information; or transmit a connection release message to the first terminal device, where the connection release message includes the first information.

Optionally, when the first sequence is transmitted to the first terminal device on the first resource, there are a plurality of first sequences. The transceiver module 702 is configured to transmit any one of the plurality of first sequences to the first terminal device on the first resource.

Optionally, the transceiver module 702 is further configured to: transmit third information to the first terminal device, where the third information is used to determine a third resource, the third resource precedes the second resource in time domain, the third resource is used by a plurality of terminal devices to receive a sequence of a second type, and the plurality of terminal devices include the first terminal device; and transmit a third sequence to the first terminal device on the third resource, where the third sequence is the sequence of the second type. The third sequence is a sequence received when the first condition is met after the first terminal device enters the idle state or the inactive state. The third sequence is used by the first terminal device to output a second prompt signal.

In an example embodiment, when the terminal device (for example, the first terminal device) or the network device is a chip, the transceiver module 702 may be a communication interface, a pin, a circuit, or the like. The communication interface may be configured to input data to be processed to a processor, and may output a processing result of the processor to the outside. During specific implementation, the communication interface may be a general purpose input/output (GPIO) interface, and may be connected to a plurality of peripheral devices (for example, a display (LCD), a camera, a radio frequency (RF) module, and an antenna). The communication interface is connected to the processor through a bus.

The processing module 701 may be a processor. The processor may execute computer-executable instructions stored in the storage module, so that the chip performs the method in the embodiment shown in FIG. 4. Further, the processor may include a controller, an arithmetic logic unit, and a register. For example, the controller is mainly responsible for instruction decoding, and transmitting a control signal for an operation corresponding to the instructions. The arithmetic logic unit is mainly responsible for performing a fixed-point or floating-point arithmetic operation, a shift operation, a logic operation, and the like, and may also perform an address operation and address translation. The register is mainly responsible for saving a quantity of register operations, intermediate operation results, and the like that are temporarily stored during instruction execution. During specific implementation, a hardware architecture of the processor may be an ASIC architecture, a microprocessor without interlocked piped stages (MIPS) architecture, an advanced reduced instruction set computer machines (ARM) architecture, a second processor (NP) architecture, or the like. The processor may be a single-core processor or a multi-core processor. The storage module may be a storage module inside the chip, for example, a register or a cache. Alternatively, the storage module may be a storage module outside the chip, for example, a ROM, another type of static storage device that can store static information and instructions, or a RAM.

It should be noted that functions respectively corresponding to the processor and the interface may be implemented by using a hardware design, or may be implemented by using a software design, or may be implemented by using a combination of software and hardware. This is not limited herein.

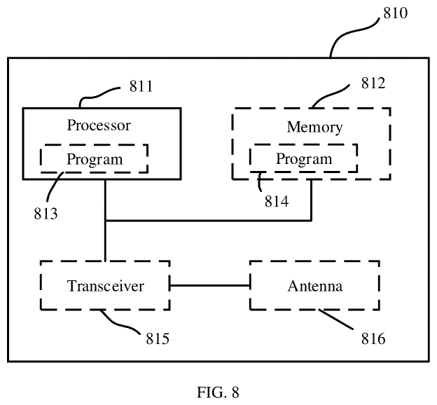

FIG. 8 is a diagram of a structure of another communication apparatus according to an embodiment of this disclosure. It may be understood that the communication apparatus 810 includes means in necessary forms such as modules, units, elements, circuits, or interfaces, which are appropriately configured together to perform the solution. The communication apparatus 810 may be the foregoing terminal device (for example, the first terminal device) or the network device, or may be a component (for example, a chip) in these devices, configured to implement the method described in the foregoing method embodiments. The communication apparatus 810 includes one or more processors 811. The processor 811 may be a general-purpose processor, a dedicated processor, or the like. For example, the processor may be a baseband processor or a central processing unit. The baseband processor may be configured to process a communication protocol and communication data. The central processing unit may be configured to: control the communication apparatus (for example, the terminal device (for example, the first terminal device), the network device, or the chip), execute a software program, and process data of the software program.

Optionally, in an example embodiment, the processor 811 may include a program 813 (which may also be referred to as code or instructions sometimes), and the program 813 may be run on the processor 811, so that the communication apparatus 810 performs the method described in the foregoing embodiments. In another example embodiment, the communication apparatus 810 includes a circuit (not shown in FIG. 8), and the circuit is configured to implement functions of the terminal device (for example, the first terminal device), the network device, or the like in the foregoing embodiments. Optionally, the communication apparatus 810 may include one or more memories 812 having a program 814 (which may also be referred to as code or instructions sometimes) stored therein. The program 814 may be run on the processor 811, so that the communication apparatus 810 performs the method described in the foregoing method embodiments.

Optionally, the processor 811 and/or the memory 812 may further store data. The processor and the memory may be separately disposed, or may be integrated together.

Optionally, the communication apparatus 810 may further include a transceiver 815 and/or an antenna 816. The processor 811 may also be sometimes referred to as a processing unit, and controls the communication apparatus (for example, the terminal device (for example, the first terminal device) or the network device). The transceiver 815 may also be sometimes referred to as a transceiver unit, a transceiver machine, a transceiver circuit, a transceiver, or the like, and is configured to implement receiving and transmitting functions of the communication apparatus through the antenna 816.

An embodiment of this disclosure further provides a communication apparatus. The communication apparatus includes at least one processor and a memory. The memory is configured to store a computer program or instructions. The at least one processor is configured to execute the computer program or the instructions in the memory, to perform the method in any one of the embodiments of FIG. 4.

An embodiment of this disclosure further provides a computer-readable storage medium. The computer-readable storage medium stores computer instructions. When the computer instructions are executed, a computer is caused to perform the method in any one of the embodiments of FIG. 4.

An embodiment of this disclosure further provides a computer program product. The computer program product includes computer program code. When the computer program code is run by a computer, the computer is caused to perform the method in any one of the embodiments of FIG. 4.

An embodiment of this disclosure further provides a chip. The chip includes at least one processor and an interface. The processor is configured to read and execute instructions stored in a memory. When the instructions are run, the chip is caused to perform the method in any one of the embodiments of FIG. 4.

The foregoing units described as separate parts may or may not be physically separate, and parts displayed as units may or may not be physical units, may be located in one position, or may be distributed on a plurality of network units. Some or all of the units may be selected based on an actual requirement, to achieve the objectives of the solutions in embodiments of this disclosure. In addition, network element units in embodiments of this disclosure may be integrated into one processing unit, each of the units may exist alone physically, or two or more units are integrated into one unit. The integrated unit may be implemented in a form of hardware, or may be implemented in a form of a software network element unit.

When the integrated unit is implemented in the form of the software network element unit and sold or used as an independent product, the integrated unit may be stored in a computer-readable storage medium. Based on such an understanding, an essentially contributing part in the technical solutions of this disclosure or all or a part of the technical solutions may be embodied in a form of a software product. A computer software product is stored in a storage medium and includes several instructions for instructing a computer device (which may be a personal computer, a terminal device, a cloud server, a network device, or the like) to perform all or some of the steps of the method in embodiments of this disclosure. The storage medium includes any medium that can store program code, such as a USB flash drive, a removable hard disk, a read-only memory (ROM), a random access memory (RAM), a magnetic disk, or an optical disc. The foregoing descriptions are merely example embodiments of this disclosure, but are not intended to limit the scope of protection of this disclosure. Any modification or replacement readily figured out by a person skilled in the art within the technical scope disclosed in this disclosure shall fall within the scope of protection of this disclosure. Therefore, the scope of protection of this disclosure shall be subject to the scope of protection of the claims.

1. A communication method, applied to a first communication apparatus, comprising:
receiving first information from a network device, wherein the first information includes information identifying a first resource, the first resource precedes a second resource in a time domain, the second resource comprises one or more paging occasions, and when the second resource comprises a plurality of paging occasions, the plurality of paging occasions are consecutive;
entering an idle state or an inactive state, and receiving a first sequence from the network device on the first resource when a first condition is met, wherein the first sequence is a sequence of a first type, and the first condition comprises at least one of: signal quality measured by the first communication apparatus is less than or equal to a first threshold, or signal quality measured by the first communication apparatus within a first time period is less than or equal to the first threshold; and
outputting a first prompt signal based on the first sequence.

2. The method according to claim 1, wherein the receiving the first information from the network device comprises:
receiving a radio resource control (RRC) configuration message from the network device, wherein the RRC configuration message comprises the first information; or
receiving a connection release message from the network device, wherein the connection release message comprises the first information.

3. The method according to claim 1, wherein the first resource is used by one or more communication apparatuses to receive the sequence of the first type, and the one or more communication apparatuses comprise the first communication apparatus.

4. The method according to claim 1, wherein
the information identifying the first resource comprises a resource index of the first resource;
the method further comprises:
obtaining identification information of a cell managed by the network device and a position of the one or more paging occasions;
generating a second sequence based on the identification information of the cell managed by the network device, the position of the one or more paging occasions, and the resource index of the first resource; and
the outputting the first prompt signal based on the first sequence comprises:
outputting the first prompt signal when the first sequence is the same as the second sequence.

5. The method according to claim 4, wherein the generating the second sequence based on the identification information of the cell managed by the network device, the position of the one or more paging occasions, and the resource index of the first resource comprises:
receiving second information from the network device, wherein the second information indicates a sequence index of the first sequence; and
generating the second sequence based on the identification information of the cell managed by the network device, the position of the one or more paging occasions, the resource index of the first resource, and the sequence index of the first sequence.

6. The method according to claim 1, further comprising:
receiving a paging message from the network device on the second resource in response to detecting a change in location of the first communication apparatus, wherein the paging message comprises an identifier of the first communication apparatus.

7. The method according to claim 1, further comprising:
receiving third information from the network device, wherein the third information includes information identifying a third resource, the third resource precedes the second resource in a time domain, the third resource is used by a plurality of communication apparatuses to receive a sequence of a second type, and the plurality of communication apparatuses comprise the first communication apparatus;
entering the idle state or the inactive state, and receiving a third sequence from the network device on the third resource when the first condition is met, wherein the third sequence is a sequence of the second type; and
outputting a second prompt signal based on the third sequence.

8. A first communication apparatus comprising:
a transceiver; and
at least one processor coupled to one or more memories storing programming instructions that, when executed by the at least one processor, cause the first communication apparatus to perform operations including:
receiving first information from a network device, wherein the first information includes information identifying a first resource, the first resource precedes a second resource in a time domain, the second resource comprises one or more paging occasions, and when the second resource comprises a plurality of paging occasions, the plurality of paging occasions are consecutive;
entering an idle state or an inactive state, and receiving a first sequence from the network device on the first resource when a first condition is met, wherein the first sequence is a sequence of a first type, and the first condition comprises at least one of: signal quality measured by the first communication apparatus is less than or equal to a first threshold, or signal quality measured by the first communication apparatus within a first time period is less than or equal to the first threshold; and
outputting a first prompt signal based on the first sequence.

9. The first communication apparatus according to claim 8, wherein the operations further include:
receiving a radio resource control (RRC) configuration message from the network device, wherein the RRC configuration message comprises the first information; or
receiving a connection release message from the network device, wherein the connection release message comprises the first information.

10. The first communication apparatus according to claim 8, wherein the first resource is used by one or more communication apparatuses to receive the sequence of the first type, and the one or more communication apparatuses comprise the first communication apparatus.

11. The first communication apparatus according to claim 8, wherein
the information identifying the first resource comprises a resource index of the first resource;
the operations further include:
obtaining identification information of a cell managed by the network device and a position of the one or more paging occasions;
generating a second sequence based on the identification information of the cell managed by the network device, the position of the one or more paging occasions, and the resource index of the first resource; and
outputting the first prompt signal when the first sequence is the same as the second sequence.

12. The first communication apparatus according to claim 11, wherein the operations further include:
receiving second information from the network device, wherein the second information indicates a sequence index of the first sequence; and
generating the second sequence based on the identification information of the cell managed by the network device, the position of the one or more paging occasions, the resource index of the first resource, and the sequence index of the first sequence.

13. The first communication apparatus according to claim 8, wherein the operations further include:
receiving a paging message from the network device on the second resource in response to detecting a change in location of the first communication apparatus, wherein the paging message comprises an identifier of the first communication apparatus.

14. The first communication apparatus according to claim 8, wherein the operations further include:
receiving third information from the network device, wherein the third information includes information identifying a third resource, the third resource precedes the second resource in a time domain, the third resource is used by a plurality of communication apparatuses to receive a sequence of a second type, and the plurality of communication apparatuses comprise the first communication apparatus;
entering the idle state or the inactive state, and receiving a third sequence from the network device on the third resource when the first condition is met, wherein the third sequence is a sequence of the second type; and
outputting a second prompt signal based on the third sequence.

15. A non-transitory computer-readable storage medium storing computer instructions that, when executed by a first communication apparatus, cause the first communication apparatus to perform operations including:
receiving first information from a network device, wherein the first information includes information identifying a first resource, the first resource precedes a second resource in a time domain, the second resource comprises one or more paging occasions, and when the second resource comprises a plurality of paging occasions, the plurality of paging occasions are consecutive;
entering an idle state or an inactive state, and receiving a first sequence from the network device on the first resource when a first condition is met, wherein the first sequence is a sequence of a first type, and the first condition comprises at least one of: signal quality measured by the first communication apparatus is less than or equal to a first threshold, or signal quality measured by the first communication apparatus within a first time period is less than or equal to the first threshold; and
outputting a first prompt signal based on the first sequence.

16. The non-transitory computer-readable storage medium according to claim 15, wherein the operations further include:
receiving a radio resource control (RRC) configuration message from the network device, wherein the RRC configuration message comprises the first information; or
receiving a connection release message from the network device, wherein the connection release message comprises the first information.

17. The non-transitory computer-readable storage medium according to claim 15, wherein the first resource is used by one or more communication apparatuses to receive the sequence of the first type, and the one or more communication apparatuses comprise the first communication apparatus.

18. The non-transitory computer-readable storage medium according to claim 15, wherein
the information identifying the first resource comprises a resource index of the first resource;
the operations further include:
obtaining identification information of a cell managed by the network device and a position of the one or more paging occasions;
generating a second sequence based on the identification information of the cell managed by the network device, the position of the one or more paging occasions, and the resource index of the first resource; and
outputting the first prompt signal when the first sequence is the same as the second sequence.

19. The non-transitory computer-readable storage medium according to claim 18, wherein the operations further include:
receiving second information from the network device, wherein the second information indicates a sequence index of the first sequence; and
generating the second sequence based on the identification information of the cell managed by the network device, the position of the one or more paging occasions, the resource index of the first resource, and the sequence index of the first sequence.

20. The non-transitory computer-readable storage medium according to claim 15, wherein the operations further include:
receiving a paging message from the network device on the second resource in response to detecting a change in location of the first communication apparatus, wherein the paging message comprises an identifier of the first communication apparatus.
